(19) United States
(12) Patent Application Publication
(10) Pub. No.: US 2011/0257943 A1
(43) Pub. Date: Oct. 20, 2011

(54) NODE-BASED TRANSIENT ACCELERATION METHOD FOR SIMULATING CIRCUITS WITH LATENCY

(75) Inventor: Gang Peter Fang, Plano, TX (US)

(73) Assignee: Texas Instruments Incorporated, Dallas, TX (US)

(21) Appl. No.: 12/761,566

(22) Filed: Apr. 16, 2010

(51) Int. Cl. G06F 17/11; G06F 17/50; G06F 17/16

(52) U.S. Cl. 703/2; 703/14

(57) ABSTRACT

When modeling a circuit, transient analysis is an important part of the analysis. However, for transient analyses, device model evaluating can consume a considerable amount of time, when using conventional simulators. Here, a simulator is provided that allows for detection of latency on a node-by-node basis, as opposed to a device-by-device basis with conventional simulators. Using this type of analysis can greatly reduce the time of an analysis, which affects both the cost of a product and its time to market.

### TECHNICAL FIELD

The invention relates generally to a circuit simulator and, more particularly, to a circuit simulator that determines latency on a node-by-node basis to decrease the time of analysis.

### BACKGROUND

Today, conventional SPICE-like circuit simulators perform transient analysis by iteratively solving nonlinear systems of equations at each time point that correspond to a circuit. Depending on the complexity of the circuits (i.e., analog/mixed signal circuits), transient analyses can take several days or weeks to complete, even with the fastest computational equipment available. In performing these simulations, conventional circuit simulators perform evaluations for nonlinear devices (such as bipolar transistors or CMOS transistors) for each iteration (and for each transient time point). The processing time for the device evaluations can comprise up to 90% of the total time to perform the transient analysis. Thus, it is highly desirable to reduce the device evaluation times.

During transient analysis, some circuit variables change less rapidly than others, which is known as latency. A circuit simulator solves a nonlinear system using an iterative method (for example, Newton-Raphson method) at each transient time point. A circuit variable could take could take fewer iterations to converge, which is referred to as iteration latency; and a circuit variable could change much slower from a time point to the next time point, which is referred to as time latency. One conventional method attempts to reduce the device evaluation times by “skipping” devices when possible. See Bill Nye, “First Order Nonlinear Device Bypass in Circuit Simulation”, IEEE Intl. Conf. on Computer-Aided Design 1988, Nov. 7-10, 1988, pp. 434-437. This conventional method takes advantage of this latency by determining which devices have changed by a small enough amount between iterations (at the same transient time point or between consecutive transient time points) that the device does not have to be reevaluated. Alternatively, an interpolation (instead of a “skip”) can also be employed to improve accuracy.

The conventional method uses device latency conditions based on device terminal voltages to determine if a device needs to be reevaluated. There are numerous problems to this approach. First and foremost, determining what difference is “small enough” can be very difficult. Oftentimes, to have an accurate simulation, the tolerances are so tight that the method is rendered useless. Additionally, even though the differences are small for a particular between iteration, there may be relative small differences on a particular tolerance (i.e., voltage change) which may create a large difference for another parameter (i.e., current). For example, there may be a small change in voltage on a transistor which creates a very large difference in current through the transistor. Moreover, the conventional method requires device latency conditions to be developed for each device model, which is difficult for complicated models, such as MEXTRAM, and impossible for user-specified-models, such as Verilog-A models. Thus, there is a need for an improved circuit simulator.

Some other simulators use a different group of methods to take advantage of circuit latency, for example, Rabbat et. al., “A Multilevel Newton Algorithm with Macromodeling and Latency for the Analysis of Large-Scale Nonlinear Circuits in the Time Domain”, IEEE Transc. Circuits Syst., vol. CAS-26, September, 1979, pp. 733-740; Cox et. al., “A Dormant Subcircuit for Maximizing Iteration Latency”, IEEE Intl. Conf. on Computer-Aided Design 1988, Nov. 7-10, 1988, pp. 438-441; U.S. Pat. No. 5,553,008; U.S. Pat. No. 6,577,992; U.S. Pat. No. 6,480,816; and U.S. Pat. No. 7,415,403. These methods partition the circuit into a number of subcircuits statically or dynamically, then at each time point determine if the evaluation of all the devices in a subcircuit can be skipped for certain subcircuits. It should be noted, however, that these methods either do not use an iterative method to solve the nonlinear circuit systems at each time point or do not allow device switching between active mode and latent mode during iterations.

### SUMMARY

A preferred embodiment of the present invention, accordingly, provides a method. The method comprises receiving a product specification for a circuit having a plurality of active devices that are coupled to one another through a plurality of nodes; generating a matrix representation of a system of equations that is generally representative of the circuit, wherein the matrix representation has a plurality of matrix rows, and wherein each matrix row corresponds to at least one of the nodes; iteratively solving the matrix representation of the system of equations for each iteration of a plurality of transient time points to generate a simulation of the circuit, wherein the step of iteratively solving includes the substeps of: determining if each node satisfies a latency condition for each iteration of each transient time point; and using a previous iteration for each matrix row when each of its nodes satisfies the latency condition.

In accordance with a preferred embodiment of the present invention, the latency condition further comprises a plurality of latency conditions.

In accordance with a preferred embodiment of the present invention, the latency conditions are based at least in part on Newton convergence criteria.

In accordance with a preferred embodiment of the present invention, the substep of determining if each node satisfies the latency conditions for each iteration of each transient time point further comprises: determining, for each node, the absolute value of the sum of currents for each iteration of each transient time point; determining, for each node, the absolute value of the change in voltage for each iteration of each transient time point; comparing, for each iteration of each transient time point, each of the absolute value of the sum of currents and the absolute value of the change in voltage to a node latency tolerance; and determining that at least one of the nodes satisfies the latency conditions for at least one of the transient time points if its absolute value of the sum of currents and its absolute value of the change in voltage are each less than the node latency tolerance.

In accordance with a preferred embodiment of the present invention, a processor is provided having a computer program product embodied thereon. The computer program product comprises computer code for receiving a product specification for a circuit having a plurality of active devices that are coupled to one another through a plurality of nodes; computer code for generating a matrix representation of a system of equations that is generally representative of the circuit, wherein the matrix representation has a plurality of matrix rows, and wherein each matrix row corresponds to at least one of the nodes; computer code for iteratively solving the matrix representation of the system of equations for each iteration of a plurality of transient time points to generate a simulation of the circuit, wherein the step of iteratively solving includes the substeps of: computer code for determining if each node satisfies a latency condition for each iteration of each transient time point; and computer code for using a previous iteration for each matrix row when each of its nodes satisfies the latency condition.

In accordance with a preferred embodiment of the present invention, the computer code for determining if each node satisfies the latency conditions for each iteration of each transient time point further comprises: computer code for determining, for each node, the absolute value of the sum of currents for each iteration of each transient time point; computer code for determining, for each node, the absolute value of the change in voltage for each iteration of each transient time point; computer code for comparing, for each iteration of each transient time point, each of the absolute value of the sum of currents and the absolute value of the change in voltage to a node latency tolerance; and computer code for determining that at least one of the nodes satisfies the latency conditions for at least one iteration at the transient time points if its absolute value of the sum of currents and its absolute value of the change in voltage are each less than the node latency tolerance.

In accordance with a preferred embodiment of the present invention, an apparatus is provided. The apparatus comprises a storage medium having a matrix solver, a device evaluator, a latency detector, a convergence checker, and a matrix loader stored thereon, and a processor having an engine embodied thereon that is in communication with the storage medium, wherein the engine: receives a product specification for a circuit having a plurality of active devices that are coupled to one another through a plurality of nodes; generates, with the matrix loader and the device evaluator, a matrix representation of a system of equations that is generally representative of the circuit, wherein the matrix representation has a plurality of matrix rows, and wherein each matrix row corresponds to at least one of the nodes; iteratively solves, with the matrix solver, the matrix loader, the latency detector, the convergence checker, the matrix representation of the system of equations for each iteration of a plurality of transient time points to generate a simulation of the circuit, wherein the engine iteratively solves by: determining with the latency detector if each node satisfies a latency condition for each iteration of each transient time point; and using a previous iteration with the matrix loader for each matrix row when each of its nodes satisfies the latency condition.

In accordance with a preferred embodiment of the present invention, the engine, with the latency detector: determines, for each node, the absolute value of the sum of currents for each iteration of each transient time point; determines, for each node, the absolute value of the change in voltage for each iteration of each transient time point; compares, for each iteration of each transient time point, each of the absolute value of the sum of currents and the absolute value of the change in voltage to a node latency tolerance; and determines that at least one of the nodes satisfies the latency conditions for at least one of the transient time points if its absolute value of the sum of currents and its absolute value of the change in voltage are each less than the node latency tolerance.

In accordance with a preferred embodiment of the present invention, the processor further comprises a personal computer.

In accordance with a preferred embodiment of the present invention, the processor further comprises a plurality of processor distributed across a computer network.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of an example of a computer network;

FIG. 2 is a diagram of an example of a system that employs a circuit simulator in accordance with a preferred embodiment of the present invention;

FIGS. 3A and 3B are flow charts of the general operation of the circuit simulator of FIG. 2; and

FIG. 4 is an example of a circuit that can be evaluated by the simulator of FIG. 2.

### DETAILED DESCRIPTION

Refer now to the drawings wherein depicted elements are, for the sake of clarity, not necessarily shown to scale and wherein like or similar elements are designated by the same reference numeral through the several views.

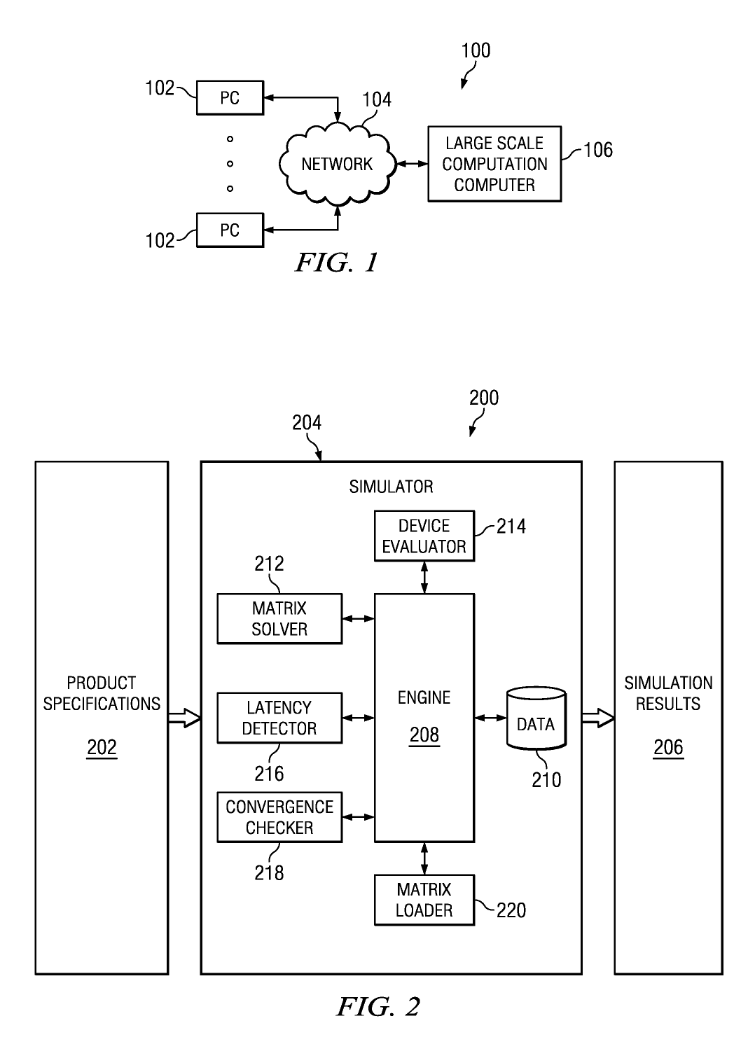

Referring to FIG. 1 of the drawings, the reference numeral 100 generally designates a computer network. Network 100 generally comprises personal computers (PCs) or terminals 102-1 to 102-n, a packet switching network 104, and a large scale computation computer 106. Each of these computers 102-1 to 102-n and 106 includes one or more processors and a storage medium (such as random access memories and hard disk drives), where the processor can execute computer program code or software instructions which are stored in the storage media. Circuit simulators (which are generally computer code or software instructions) generally take many forms and which can operate on one or more of the PCs 102-1 to 102-n or over the network 100 (where computer 106 performs at least a portion of the computations).

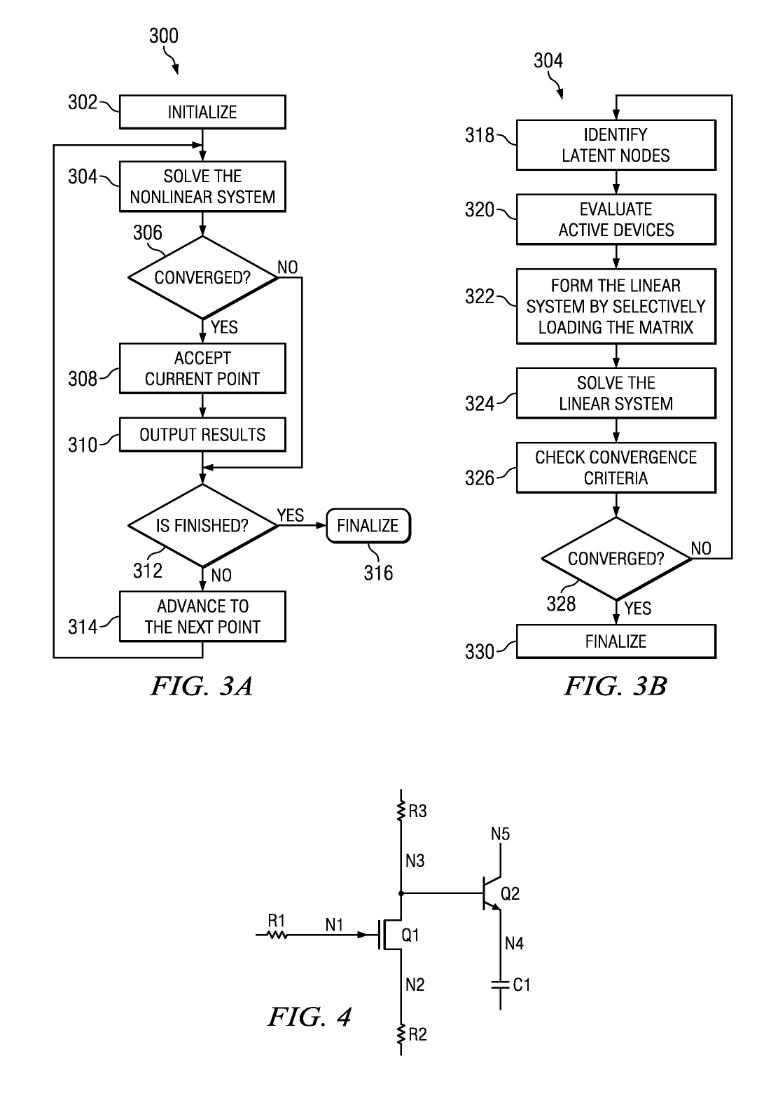

Turning to FIG. 2, a system 100 is shown, which generates simulations results 206 from product specifications 202 (which generally includes a subject circuit). In order to accomplish this, the system 200 employs simulator 204. The simulator 204 comprises an engine 208 that interacts with a matrix solver 212, a device evaluator 214, data (stored in a database 210), a convergence checker 218, and a matrix loader 220. The engine 204 uses each of these modules 212, 214, 216, 218, and 220 to perform a transient analysis for a subject circuit (generally defined in the specifications 202) for several transient time points. The general operation of the simulator 206 can be seen can be seen in FIGS. 3A and 3B, where the outer loop (represented by reference numeral 300) performs transient analysis by advancing time points while the inner loop (represented by flow chart 304) solves the nonlinear system of equations at each time point using an iterative method, often a variation of Newton-Raphson method.

Looking first to step 302, the simulator 204 performs an initialization. During this step, engine 208 uses the matrix loader 220 to generate a matrix representation for a system of equations that represents the subject circuit (that is generally defined in the product specifications 202). Typically, the system of equations is a nodal analysis that uses Kirchoff's current law (KCL) with an equation representing each node, so that each row of the matrix representation generally represents a node of the subject circuit (that is generally defined in the product specifications 202). In making this analysis, the transient behavior of a node of a circuit can be modeled as follows:

$$i ( v ( t ) ) + \frac{d q ( v ( t ) )}{d t} + u ( t ) = 0 , \qquad ( 1 )$$

where v(0)=a. Simulator 204, then, solves the system of discretized equations that represents the subject circuit (that is generally defined in the product specifications 202) for each time point, in step 304 (which generally corresponds to the inner loop). There are several time integration schemes to discretize the differential term in the equation (1). The system of discretized equations based backward Euler scheme is shown below,

$$f ( {v}_{m} ) = i ( {v}_{m} ) + \frac{q ( {v}_{m} ) - q ( {v}_{m - 1} )}{{t}_{m} - {t}_{m - 1}} + {u}_{m} = 0 , \qquad ( 2 )$$

where m is the time point index.

When solving the system of equations for a time point, simulator 204, initially in step 318, can then identify latent nodes. Generally, the engine 208 employs the latency detector 216 to evaluate each node of the subject circuit (that is generally defined in the product specifications 202) to determine if the node satisfies predetermined or user defined latency conditions between consecutive transient time points or consecutive iterations. Typically, the latency conditions are based at least in part on Newton criteria, where the absolute value of the sum of the currents into a node (KCL error) and the absolute value of the change in voltage at a node (update error) are each compared to a predetermined or user defined node latency tolerances. These latency tolerances are typically a fraction of the Newton tolerances with a scaling constant between 0 and 1. If a node satisfies both conditions between consecutive transient time points or consecutive iterations, then node is determined to be latent.

Following the evaluation for node latency, simulator 204 evaluates all of the “active devices” in step 320. Generally, engine 204 uses the device evaluator 214 to evaluate each “active device.” The “active devices” are generally defined as nonlinear devices (such as bipolar or CMOS transistors) where at least one of the nodes coupled to the device is not latent. An example can be seen in FIG. 4. In this example, nodes N1, N2, N3, and N5 are latent, while node N4 is not latent. As a result, NMOS transistor Q1 is a “latent device”, and NPN transistor Q2 is an “active device.” Additionally, passive elements (such as resistors R1, R2, and R3 and capacitor C1 of FIG. 4) are generally not evaluated.

With the evaluation of active devices, simulator 204 can then construct the matrix representation for an iteration of the inner loop 304. Generally, the engine 208 employs the matrix loader 220 to construct the matrix representation. The matrix loader 220 generates matrix rows for those “active devices” evaluated in step 318, while loading the matrix rows from the previous iteration of the inner loop 304 for those “latent devices.”

With the matrix representation complete, the simulator 204 then evaluates the matrix representation in steps 322, 324, and 326. In step 322, the engine 208 uses the matrix solver 212 to solve the matrix representation. Generally, during a Newton iteration, matrix solver 212 solves the matrix representation such that for equation (3) above:

vₘ^{k+1}=vₘ^{k}−J⁻¹(vₘ^{k})(f(vₘ^{k})), (3)

where J is the circuit Jacobian matrix and k is the Newton iteration index. In steps 324 and 326, the engine 208 uses the convergence checker 218 to compare the solution determined in step 322 satisfies the convergence criteria. Generally, the convergence criteria for each node are as follows:

$$\begin{matrix}\vert {v}_{m}^{k} - {v}_{m}^{k - 1} \vert < ɛ ( max ( \vert {v}_{m}^{k} \vert , \vert {v}_{m}^{k - 1} \vert ) ) + γ , & ( 4 ) \\ \vert {f}_{n} ( {v}_{m}^{k} ) \vert < ɛ ( {\sum }_{j} \vert {i}_{n , j} ( {v}_{m}^{k} ) \vert ) + η , & ( 5 )\end{matrix}$$

where ε is a relative tolerance, γ is an absolute voltage tolerance, η is an absolute current tolerance, n is the node index, and j is the index of the current that flow into the same node. If the convergence criteria has been satisfied for each node, then the simulation results 206 are produced in step 330; however, if the convergence criteria have not been met, then the process begins again in step 318 for a subsequent iteration.

Following convergence of the solution for the system of equations for inner loop 304, simulator 204 performs a subsequent convergence check in step 306. Similar to step 328, the engine 208 uses the convergence checker 218 to compare the solution determined in step 322 satisfies the convergence criteria; however, the convergence criteria is different. In step 306, a determination is made as to the time point has converged. If the criteria for convergence is met in step 306, the results of output in steps 308 and 310. When either the convergence criteria have not been met in step 306 or the results are output in step 310, a determination is made as to whether the simulation is complete in step 312. If complete, the results are finalized in step 316; otherwise, the simulator 206 advances to the next time point in step 314 to begin another iteration.

As a result of employing the simulator 204, a significant increase in the overall speed of a transient modeling can be seen. Typically, a standard class-D amplifier or phase locked loop (PLL) is used to benchmark the speed of simulators. When comparing simulators that employ the conventional “skip” methodologies (as discussed above) to simulator 204, the overall speed is increased by 2 to 3 times, with much greater accuracy. Moreover, there are several other advantages that can be realized with simulator 204 (compared to conventional simulators), such as: simulator 204 generally eliminates the need for developing latency conditions for each individual nonlinear device models; simulator 204 works well with user-defined models; simulator 204 allows for adaptive user-defined Newton convergence tolerances; KCL criterion are considered (which are generally used for large nonlinear capacitors); and simulator 204 allows for faster matrix formulation.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Accordingly, it is appropriate that the appended claims be construed broadly and in a manner consistent with the scope of the invention.

1. A method comprising:
receiving a product specification for a circuit having a plurality of active devices that are coupled to one another through a plurality of nodes;
generating a matrix representation of a system of equations that is generally representative of the circuit, wherein the matrix representation has a plurality of matrix rows, and wherein each matrix row corresponds to at least one of the nodes;
iteratively solving the matrix representation of the system of equations for each of a plurality of transient time points to generate a simulation of the circuit, wherein the step of iteratively solving includes the substeps of:
determining if each node satisfies a latency condition for each iteration of each transient time point; and
using a previous iteration for each matrix row when each of its nodes satisfies the latency condition.

2. The method of claim 1, wherein the latency condition further comprises a plurality of latency conditions.

3. The method of claim 2, wherein the latency conditions are based at least in part on Newton convergence criteria.

4. The method of claim 3, wherein the substep of determining if each node satisfies the latency conditions for each iteration of each transient time point further comprises:
determining, for each node, the absolute value of the sum of currents for each iteration of each transient time point;
determining, for each node, the absolute value of the change in voltage for each iteration of each transient time point;
comparing, for each iteration of each transient time point, each of the absolute value of the sum of currents and the absolute value of the change in voltage to a node latency tolerance; and
determining that at least one of the nodes satisfies the latency conditions for at least one iteration for at least one of the transient time points if its absolute value of the sum of currents and its absolute value of the change in voltage are each less than the node latency tolerance.

5. A processor having a computer program product embodied thereon, the computer program product comprising:
computer code for receiving a product specification for a circuit having a plurality of active devices that are coupled to one another through a plurality of nodes;
computer code for generating a matrix representation of a system of equations that is generally representative of the circuit, wherein the matrix representation has a plurality of matrix rows, and wherein each matrix row corresponds to at least one of the nodes;
computer code for iteratively solving the matrix representation of the system of equations for each of a plurality of transient time points to generate a simulation of the circuit, wherein the step of iteratively solving includes the substeps of:
computer code for determining if each node satisfies a latency condition for each iteration of each transient time point; and
computer code for using a previous iteration for each matrix row when each of its nodes satisfies the latency condition.

6. The computer program product of claim 5, wherein the latency condition further comprises a plurality of latency conditions.

7. The computer program product of claim 6, wherein the latency conditions are based at least in part on Newton convergence criteria.

8. The computer program product of claim 7, wherein the computer code for determining if each node satisfies the latency conditions for iteration of each transient time point further comprises:
computer code for determining, for each node, the absolute value of the sum of currents for each iteration of each transient time point;
computer code for determining, for each node, the absolute value of the change in voltage for each iteration of each transient time point;
computer code for comparing, for each iteration of each transient time point, each of the absolute value of the sum of currents and the absolute value of the change in voltage to a node latency tolerance; and
computer code for determining that at least one of the nodes satisfies the latency conditions for at least one of the transient time points if its absolute value of the sum of currents and its absolute value of the change in voltage are each less than the node latency tolerance.

9. An apparatus comprising:
a storage medium having a matrix solver, a device evaluator, a latency detector, a convergence checker, and a matrix loader stored thereon, and
a processor having an engine embodied thereon that is in communication with the storage medium, wherein the engine:
receives a product specification for a circuit having a plurality of active devices that are coupled to one another through a plurality of nodes;
generates, with the matrix loader and the device evaluator, a matrix representation of a system of equations that is generally representative of the circuit, wherein the matrix representation has a plurality of matrix rows, and wherein each matrix row corresponds to at least one of the nodes;
iteratively solves, with the matrix solver, the matrix loader, the latency detector, ad the convergence checker, the matrix representation of the system of equations for each of a plurality of transient time points to generate a simulation of the circuit, wherein the engine iteratively solves by:
determining with the latency detector if each node satisfies a latency condition for each iteration of each transient time point; and
using a previous iteration with the matrix loader for each matrix row when each of its nodes satisfies the latency condition.

10. The apparatus of claim 9, wherein the latency condition further comprises a plurality of latency conditions.

11. The apparatus of claim 10, wherein the latency conditions are based at least in part on Newton convergence criteria.

12. The apparatus of claim 11, wherein the engine, with the latency detector:
determines, for each node, the absolute value of the sum of currents for each iteration of each transient time point;
determines, for each node, the absolute value of the change in voltage for each iteration of each transient time point;
compares, for each transient time point, each of the absolute value of the sum of currents and the absolute value of the change in voltage to a node latency tolerance; and
determines that at least one of the nodes satisfies the latency conditions for at least one of the transient time points if its absolute value of the sum of currents and its absolute value of the change in voltage are each less than the node latency tolerance.

13. The apparatus of claim 9, wherein the processor further comprises a personal computer.

14. The apparatus of claim 9, wherein the processor further comprises a plurality of processor distributed across a computer network.
